(19) United States
(12) Patent Application Publication
(10) Pub. No.: US 2015/0360558 A1
(43) Pub. Date: Dec. 17, 2015

(54) VEHICLE

(71) Applicant: TOYOTA JIDOSHA KABUSHIKI KAISHA, Toyota-shi (JP)

(72) Inventor: Seigen MAENO, Toyota-shi (JP)

(73) Assignee: TOYOTA JIDOSHA KABUSHIKI KAISHA, Toyota-shi (JP)

(21) Appl. No.: 14/737,832

(22) Filed: Jun. 12, 2015

(30) Foreign Application Priority Data
Jun. 16, 2014 (JP) 2014-123765

(51) Int. Cl. B60K 11/02; B60L 8/00

(52) U.S. Cl. CPC B60K 11/02; B60L 8/003; Y10S 903/903

(57) ABSTRACT

To increase electric power generation efficiency of a solar panel while effectively using heat accumulated in the solar panel, a panel-side pipe is installed on a rear surface of the solar panel. The panel-side pipe is connected to an engine coolant passage. When a power switch is in an OFF state, and an exchange condition for a coolant is satisfied, an engine ECU drives a water pump to circulate the coolant to the panel-side pipe. Consequently, the cool coolant accumulated in the engine coolant passage and the warmed coolant accumulated in the panel-side pipe are exchanged with each other. As a result, the solar panel is cooled, and the engine is warmed.

### BACKGROUND OF THE INVENTION

1. Field of the Invention

The present invention relates to a vehicle including a solar panel installed thereon.

2. Description of the Related Art

Hitherto, there has been known a vehicle including a solar panel on a roof, and being configured to use electric power generated by the solar panel to supply electric power to various loads.

For example, an electric vehicle proposed in Japanese Patent Application Laid-open No. 2000-323185 includes a cooler for cooling a rechargeable battery serving as a drive power supply for the vehicle, and is configured to supply electric power for operating the cooler from a solar panel.

### SUMMARY OF THE INVENTION

A user of a vehicle selects a location good in an insolation condition for parking the vehicle, thereby generating electric power from a solar panel as much as possible. However, the solar panel (solar cell) faces such a problem that electric power generation efficiency decreases as the temperature increases. To cope with this problem, in Japanese Patent Application Laid-open No. Hei 04-356213, there is proposed a solar car having an air flow passage formed on a rear side of a solar panel, and being configured to activate, when a panel temperature is higher than a predetermined temperature, a cross-flow fan so that the air flows through the air flow passage. However, the heat accumulated in the solar panel is not effectively used either on the solar car proposed in Japanese Patent Application Laid-open No. Hei 04-356213.

On the other hand, if the engine is cool when the vehicle is activated, heat for warming up the engine is necessary. In general, if the engine is warm when the vehicle is activated on a hybrid vehicle, a travel can be started by a motor torque alone without activating the engine, but if the engine is cool, a warmup operation is carried out. Therefore, a part of a fuel is used for the warmup operation, which thus causes a decrease in fuel efficiency. Moreover, a quality of an exhaust gas decreases in the warmup operation compared with that during an optimal operation of the engine.

As described above, a state in which heat radiation is required on the solar panel side and heat absorption is required on the engine side occurs on the same vehicle. However, the heat is not effectively used on the same vehicle.

The present invention has been made in view of the above-mentioned problem, and therefore has an object to enable quick warmup of an engine by increasing a temperature of an engine coolant by effectively using heat accumulated in a solar panel, and to increase the electric power generation efficiency of the solar panel.

In order to achieve the above-mentioned object, one feature of one embodiment of the present invention resides in a vehicle, including:

a solar panel (100) installed on the vehicle;

a panel-side pipe (111) arranged in a region on a rear surface side, which is an opposite side to a light reception surface, of the solar panel, so as to enable heat exchange with the solar panel;

an engine cooling device (60) for circulating a coolant through an engine coolant passage (61);

a coupling pipe (112) including an outward passage (112a) and an inward passage (112b), for coupling the engine coolant passage and the panel-side pipe to each other; and

an engine-panel coolant exchange device (50, 130, S28, S29) for drawing the coolant in the engine coolant via the outward passage to the panel-side pipe via the outward passage, and returning the coolant in the panel-side pipe to the engine coolant passage via the inward passage.

The present invention is applied to a vehicle having an engine (internal combustion engine) installed thereon. A solar panel including a solar cell for generating electric power with use of sunlight energy is installed on this vehicle. Electric power generation efficiency of the solar cell decreases as the temperature increases. On the other hand, in a case where the engine is cool when the vehicle is activated, the warmup operation is carried out. Thus, according to the present invention, the heat of the solar panel is effectively used for warming up the engine.

The vehicle according to one embodiment of the present invention includes the panel-side pipe, the engine cooling device, the coupling pipe, and the engine-panel coolant exchange device as described above. The panel-side pipe is arranged in the region on the rear surface side, which is the opposite side to the light reception surface, of the solar panel, so as to enable heat exchange with the solar panel. The engine cooling device circulates the coolant to the engine coolant passage, thereby cooling the engine. The engine coolant passage and the panel-side pipe are coupled to each other by the coupling pipe including the outward passage and the inward passage. Thus, the coupling pipe may be used to communicate the engine coolant passage and the panel-side pipe with each other, thereby drawing the coolant in the engine coolant passage to the panel-side pipe, controlling the coolant in the engine coolant passage to flow to the panel-side pipe, and exchanging the coolant in the engine coolant passage and the coolant in the panel-side pipe with each other.

The engine-panel coolant exchange device draws the coolant in the engine coolant passage to the panel-side pipe via the outward passage, and returns the coolant in the panel-side pipe to the engine coolant passage via the outward passage.

The solar panel is installed at a position that is likely to be irradiated by the sunlight, and thus easily reaches a high temperature, and the coolant at a high temperature as a result of the heat exchange with the solar panel is accumulated in the panel-side pipe. Therefore, when the engine is stopped, or the engine is activated, by operating the engine-panel coolant exchange device, the coolant at the high temperature accumulated in the panel-side pipe may be returned to the engine coolant passage, thereby warming up the engine. Simultaneously, the cool coolant in the engine coolant passage may be drawn to the solar panel-side pipe, thereby cooling the solar panel.

As a result, according to the one embodiment of the present invention, the heat accumulated in the solar panel may be effectively used to warm up the engine. Thus, the fuel efficiency can be increased, and the quality of the exhaust gas can be increased. Simultaneously, the electric power generation efficiency of the solar panel may be increased.

A feature according to one embodiment of the present invention resides in that the engine cooling device includes an electric pump (70, 71) for circulating the coolant through the engine coolant passage, and the engine-panel coolant exchange device is configured to use the electric pump to draw the coolant in the engine coolant passage to the panel-side pipe.

According to one embodiment of the present invention, the electric pump of the engine cooling device may be used to draw the coolant in the engine coolant passage to the panel-side pipe. Therefore, a special pump does not need to be newly installed, and the embodiment may be realized at a low cost.

A feature according to one embodiment of the present invention resides in that the vehicle further includes draining means (50, 130, S1, S40) for draining, when a start of a travel of the vehicle is expected, the coolant from the panel-side pipe via a part of the inward passage.

When the panel-side pipe is filled with the coolant, motion performance of the vehicle may decrease due to a weight balance of the vehicle. Particularly, for a vehicle including the solar panel on the roof, when the panel-side pipe is filled with the coolant, the center of gravity moves upward, and this tendency thus increases. Therefore, according to the one embodiment of the present invention, the draining means is installed. When a start of a travel of the vehicle is expected, the draining means drains the coolant from the panel-side pipe via a part of the inward passage. For example, the draining means detects an activation operation (turn-on operation on a power switch or an ignition switch) for the vehicle, and then drains the coolant from the panel-side pipe. As a result, the state in which the coolant has been drained from the panel-side pipe is maintained during the travel of the vehicle. Thus, the decrease in the motion performance of the vehicle can be suppressed.

A feature according to one embodiment of the present invention resides in that the vehicle further includes:

temperature acquisition means (S21, S22) for acquiring an engine-side temperature (Te) representing a temperature of the coolant in the engine coolant passage, and a panel-side temperature (Tp) representing one of a temperature of the solar panel and a temperature of the coolant in the panel-side pipe; and

exchange control means (50, S24, S25, S28, S29, S32, S33) for controlling an operation of the engine-panel coolant exchange device based on the acquired engine-side temperature and panel-side temperature.

According to the one embodiment of the present invention, the temperature acquisition means and the exchange control means are installed. The temperature acquisition means acquires the engine-side temperature representing the temperature of the coolant in the engine coolant passage, and the panel-side temperature representing the temperature of the solar panel or the temperature of the coolant in the panel-side pipe. As a result, a temperature state of the engine and a temperature state of the solar panel may be recognized. The exchange control means controls the operation of the engine-panel coolant exchange device based on the engine-side temperature and the panel-side temperature. Thus, cooling processing for the solar panel, and warming processing for the engine may be appropriately carried out.

A feature according to one embodiment of the present invention resides in that the exchange control means is configured to activate the engine-panel coolant exchange device under a condition that the panel-side temperature is higher than the engine-side temperature by an amount equal to or more than an exchange set temperature difference (Aref) (S32, S33, S28, S29).

When the panel-side temperature is higher than the engine-side temperature by a certain degree, the heat transfer by the coolant may be appropriately carried out, but otherwise, an adverse effect may arise. Thus, according to the one embodiment of the present invention, under the condition that the panel-side temperature is higher than the engine-side temperature by the amount equal to or more than the exchange set temperature difference, the exchange means operates the engine-panel coolant exchange device. Thus, the heat transfer by the coolant may be appropriately carried out.

A feature according to one embodiment of the present invention resides in that the exchange control means is configured to operate the engine-panel coolant exchange device under a condition that the panel-side temperature is higher than a panel-side exchange set temperature, and the engine-side temperature is lower than an engine-side exchange set temperature set to a temperature lower than the panel-side exchange set temperature (S24, S25, S28, S29).

According to the one embodiment of the present invention, under a condition that the panel-side temperature is higher than the panel-side exchange set temperature, and the engine-side temperature is lower than the engine-side exchange set temperature (<panel-side exchange set temperature), the exchange control means operates the engine-panel coolant exchange device. Thus, the heat transfer by the coolant may be appropriately carried out.

In the description above, reference symbols used in embodiments are enclosed in parentheses, and are assigned to respective configurations of the invention corresponding to the embodiments in order to more readily understand the invention, but each component of the invention is not limited to the embodiment prescribed by the reference symbol.

### BRIEF DESCRIPTION OF THE DRAWINGS

FIG. 1 is a schematic configuration diagram illustrating a hybrid vehicle (vehicle) according to an embodiment of the present invention.

FIG. 2 is a cooling circuit diagram illustrating an engine and a solar panel.

FIG. 3 is a schematic cross sectional view illustrating a cooling structure of the solar panel.

FIG. 4 is an operation explanatory diagram illustrating a flow of a coolant during a warmup operation.

FIG. 5 is an operation explanatory diagram illustrating a flow of the coolant during a normal operation.

FIG. 6 is a flowchart illustrating an engine-panel coolant exchange control routine (main routine).

FIG. 7 is a flowchart illustrating a filling routine (subroutine).

FIG. 8 is a flowchart illustrating an engine warming/panel cooling routine (subroutine).

FIG. 9 is a flowchart illustrating a draining routine (subroutine).

FIG. 10 is an operation explanatory diagram illustrating a flow of the coolant during filling.

FIG. 11 is an operation explanatory diagram illustrating a flow of the coolant during panel cooling.

FIG. 12 is an operation explanatory diagram illustrating a flow of the coolant during draining.

FIG. 13 is a flowchart illustrating a modified example of the engine warming/panel cooling routine (subroutine).

### DETAILED DESCRIPTION OF THE PREFERRED EMBODIMENTS

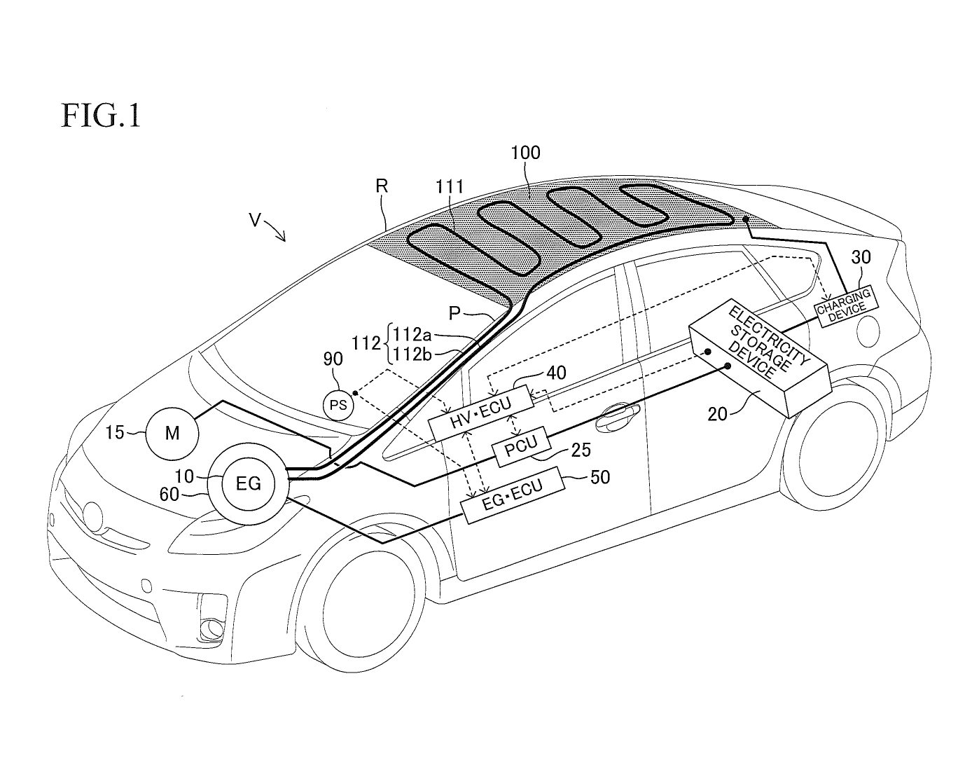

A description is now given of a vehicle according to an embodiment of the present invention referring to the drawings. FIG. 1 illustrates a schematic configuration of a vehicle V according to the embodiment.

The vehicle V according to this embodiment is a hybrid vehicle of a plug-in type including a hybrid system and a photovoltaic power generation system. The hybrid system includes an engine 10 and a motor 15 for generating a driving force for travel of the vehicle V, an electricity storage device 20, a power control unit 25, a charging device 30, a hybrid electronic control unit 40 (referred to as hybrid ECU 40), and an engine electronic control unit 50 (referred to as engine ECU 50).

The electricity storage device 20 includes a high voltage battery used as a drive power supply mainly for the motor 15, a low voltage battery used as a power supply for 12-V system in-vehicle loads, and an SOC sensor for detecting a state of charge (SOC) of each of the batteries. The charging device 30 includes a charging circuit for charging the electricity storage device 20 with an electric power generated by the photovoltaic power generation system, and an electric power supplied from an external power supply device (such as a charging station and a household electrical outlet) via a charging cable. The power control unit 25 carries out electric power supply from the electricity storage device 20 (high voltage battery) to the motor 15, and electric power regeneration from the motor 15 to the electricity storage device 20 (high voltage battery), and includes an inverter, which is a motor drive circuit, and a voltage conversion circuit.

The hybrid ECU 40 includes a microcomputer as a principal component, and is connected to the engine ECU 50 for mutual communication. The hybrid ECU 40 calculates an engine requested output value and a motor requested torque value (a driving torque and a regeneration braking torque) based on sensor signals representing driver operation amounts, which are an accelerator operation amount and a brake operation amount, sensor signals representing motion states of the vehicle V, and an SOC sensor signal of the electricity storage device 20. The hybrid ECU 40 transmits the calculated engine requested output value to the engine ECU 50, and simultaneously controls an operation of the power control unit 25 based on the motor requested torque value. Moreover, while monitoring an electricity storage state of the electricity storage device 20, the hybrid ECU 40 controls the operation of the charging device 30 based on the electricity storage state.

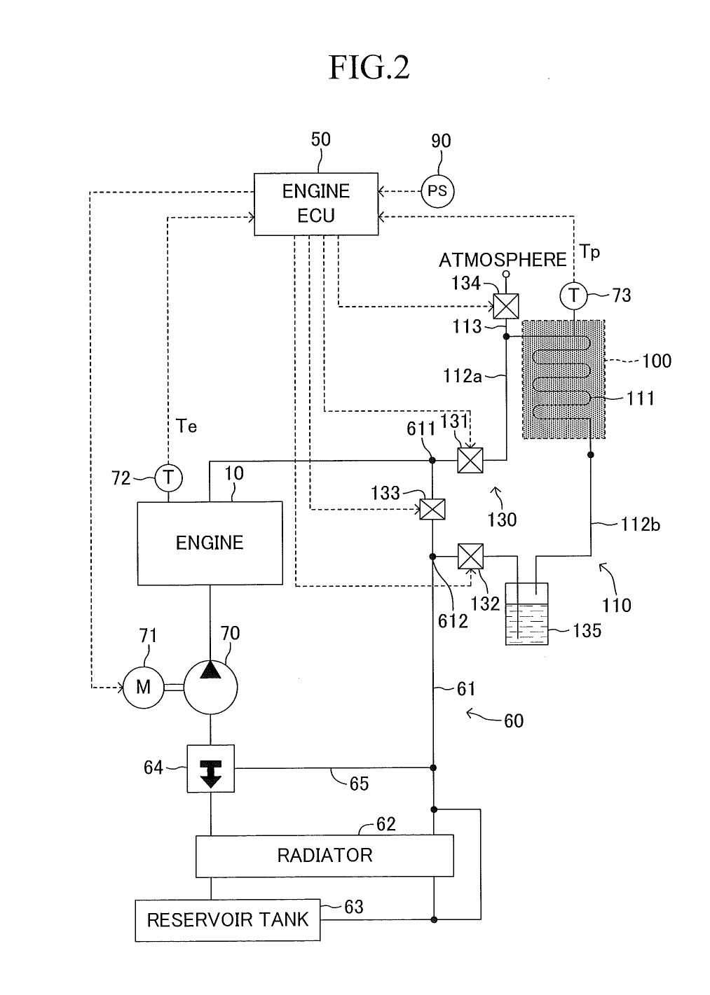

The engine ECU 50 includes a microcomputer as a principle component, and controls an operation of the engine 10 by following the engine requested output value transmitted from the hybrid ECU 40. Moreover, the engine ECU 50 incorporates a motor drive circuit for driving a water pump 70 (refer to FIG. 2) of an engine cooling device 60 for cooling the engine 10, and controls drive of a motor 71 so that the water pump 70 rotates at a target rotational speed during the operation of the engine 10. Moreover, the engine ECU 50 also includes a function part for carrying out engine-panel coolant exchange control of using the water pump 70 of the engine cooling device 60 thereby to control the coolant to flow to a panel-side pipe 111 (described later) installed in the photovoltaic power generation system. A description is later given of the engine-panel coolant exchange control.

As illustrated in FIG. 2, the engine cooling device 60 includes an engine coolant passage 61 for circulating the coolant through parts to be cooled (a cylinder head and a cylinder block) of the engine 10. On the engine coolant passage 61, a radiator 62, a reservoir tank 63, the water pump 70, and a thermostat valve 64 are installed. Moreover, on the engine coolant passage 61, a bypass passage 65 for bypassing the radiator 62 and the reservoir tank 63 to circulate the coolant to the engine 10 is formed. An outlet opening of the bypass passage 65 is coupled to the thermostat valve 64.

The thermostat valve 64 is arranged on an inlet opening side of the water pump 70. When the temperature of the coolant in a valve housing of the thermostat valve 64 is lower than a warmup end temperature (such as 80° C.), the thermostat valve 64 shuts off a communication between the radiator 62 and the water pump 70, and opens a communication between the bypass passage 65 and the water pump 70. On this occasion, a valve position of the thermostat valve 64 is referred to as warmup position. Moreover, when the coolant temperature is equal to or higher than the warmup end temperature, the thermostat valve 64 opens the communication between the radiator 62 and the water pump 70, and shuts off the communication between the bypass passage 65 and the water pump 70. On this occasion, a valve position of the thermostat valve 64 is referred to as normal position.

In the following, the flow passage through which the coolant circulates while bypassing the radiator 62 and the reservoir tank 63 when the thermostat valve 64 is at the warmup position is referred to as engine coolant warmup flow passage. Moreover, the flow passage through which the coolant circulates via the radiator 62 and the reservoir tank 63 when the thermostat valve 64 is at the normal position is referred to as engine coolant normal flow passage.

The water pump 70 is an electric water pump, and includes the pump motor 71. The pump motor 71 is driven by a drive current supplied from the engine ECU 50. Thus, the engine ECU 50 constructs a part of the engine cooling device 60. An operation of supplying a current to the pump motor 71 so as to operate the water pump 70 is herein referred to as “driving the water pump 70”.

A temperature sensor 72 (hereinafter referred to as engine-side temperature sensor 72) for detecting a temperature of the coolant flowing through the parts to be cooled (coolant passages formed in the cylinder head and the cylinder block) of the engine 10 is installed in the engine cooling device 60. The engine-side temperature sensor 72 outputs a detection signal representing a detected engine coolant temperature Te to the engine ECU 50. The engine ECU 50 outputs information representing the engine coolant temperature Te to the hybrid ECU 40.

The hybrid ECU 40 activates the hybrid system when the driver turns on a power switch 90. The hybrid ECU 40 calculates the motor requested torque value and the engine requested output value depending on the operation amounts by the driver and a vehicle state, controls drive of the motor 15 based on the motor requested torque value, and transmits the engine requested output value to the engine ECU 50. In this case, when the engine coolant temperature Te is lower than a set temperature (such as the warmup end temperature), the hybrid ECU 40 always calculates the engine requested output value so that the engine 10 and the water pump 70 are activated. Thus, when the power switch 90 is turned on, and the engine coolant temperature Te is lower than the set temperature, a warmup operation is carried out. On the other hand, when the engine coolant temperature Te is equal to or higher than the set temperature, the warmup operation is omitted. Therefore, a travel only by the motor 15 is enabled after the activation of the hybrid system while the engine 10 is stopped.

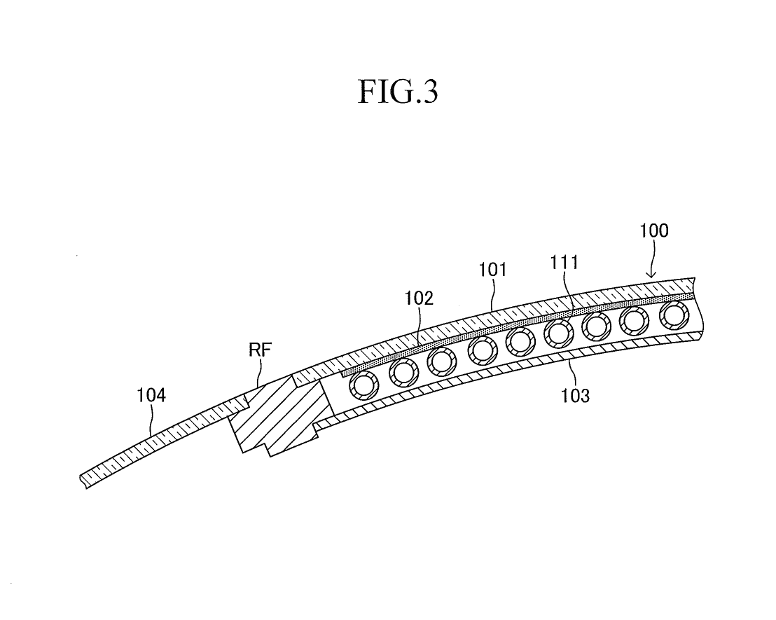

A description is now given of the photovoltaic power generation system. The photovoltaic power generation system includes a solar panel 100 installed on a roof R of the vehicle V, and a panel cooling device 110 for cooling the solar panel 100. As illustrated in FIG. 3, the solar panel 100 includes a transparent glass plate 101 and a solar cell 102 in a thin film form, which is bonded on a rear surface of the transparent glass plate 101. The transparent glass plate 101 is fixed to a roof frame RF of the vehicle V.

The panel cooling device 110 includes the panel-side pipe 111 arranged on a rear surface (a surface on an opposite side to a light reception surface to be irradiated by sunlight) of the solar panel 100 so as to enable heat exchange with the solar panel 100, a coupling pipe 112 for coupling the panel-side pipe 111 and the engine coolant passage 61 to each other, and a cooling actuator 130 (refer to FIG. 2) for carrying out switching of the passage through which the coolant flows and the like. The coupling pipe 112 includes an outward passage pipe 112a and an inward passage pipe 112b as illustrated in FIG. 1. This panel cooling device 110 is configured to share a part (the engine ECU 50, the water pump 70, and the engine coolant passage 61) of the engine cooling device 60, thereby circulating the engine coolant to the panel-side pipe 111.

The panel-side pipe 111 is arranged over an entire area on the rear surface side of the solar panel 100 for the heat exchange with the solar panel 100, and is bent into a U shape on both ends in a vehicle widthwise direction (or both ends in a vehicle lengthwise direction) so as to form a meandering shape. One end of the panel-side pipe 111 is connected to one end of the outward passage pipe 112a, and the other end of the panel-side pipe 111 is connected to one end of the inward passage pipe 112b. The coupling pipe 112 (the outward passage pipe 112a and the inward passage pipe 112b) is fixed to, for example, a pillar P of the vehicle V. As illustrated in FIG. 3, the panel-side pipe 111 is covered by a cover 103 from below so as to be invisible in a cabin. In FIG. 3, reference numeral 104 denotes a front windshield of the vehicle V.

As illustrated in FIG. 2, the other end of the outward passage pipe 112a is connected to a first position 611 of the engine coolant passage 61 through which the coolant of the engine cooling device 60 circulates, and the other end of the inward passage pipe 112b is connected to a second position 612 of the engine coolant passage 61. The first position 611 and the second position 612 are positions included in the engine coolant warmup flow passage. Moreover, the second position 612 is downstream of the first position 611 in the engine coolant passage 61.

The cooling actuator 130 includes a first on-off valve 131, a second on-off valve 132, a third on-off valve 133, and a fourth on-off valve 134. The first on-off valve 131, the second on-off valve 132, and the fourth on-off valve 134 are normally closed electromagnetic valves each of which opens only when a current is supplied, and the third on-off valve 133 is a normally open electromagnetic valve which closes only when a current is supplied. The first on-off valve 131 is installed in the outward passage pipe 112a, and the second on-off valve 132 is installed in the inward passage pipe 112b. The first on-off valve 131 and the second on-off valve 132 are preferably installed in an engine room. The third on-off valve 133 is installed between the first position 611 and the second position 612 on the engine coolant passage 61. An atmospheric relief pipe 113 is installed on the roof R of the vehicle V so as to branch from one end side of the outward passage pipe 112a or one end side of the panel-side pipe 111. A distal end of the atmospheric relief pipe 113 is open to the atmosphere. The fourth on-off valve 134 is installed on the atmospheric relief pipe 113.

The first on-off valve 131, the second on-off valve 132, the third on-off valve 133, and the fourth on-off valve 134 are respectively connected to the engine ECU 50, and the open/closed state of each of the on-off valves is controlled by a valve drive signal output from the engine ECU 50.

Moreover, a reservoir 135 having a gas/liquid separation function is positioned between the second on-off valve 132 and the panel-side pipe 111 on the inward passage pipe 112b. This reservoir 135 is arranged at a position lower than the roof R such as the inside of the engine room.

Moreover, a temperature sensor 73 (hereinafter referred to as panel-side temperature sensor 73) for detecting a temperature of the coolant in the panel-side pipe 111 is installed on the panel-side pipe 111. The panel-side temperature sensor 73 outputs a detection signal representing a detected panel-side coolant temperature Tp to the engine ECU 50.

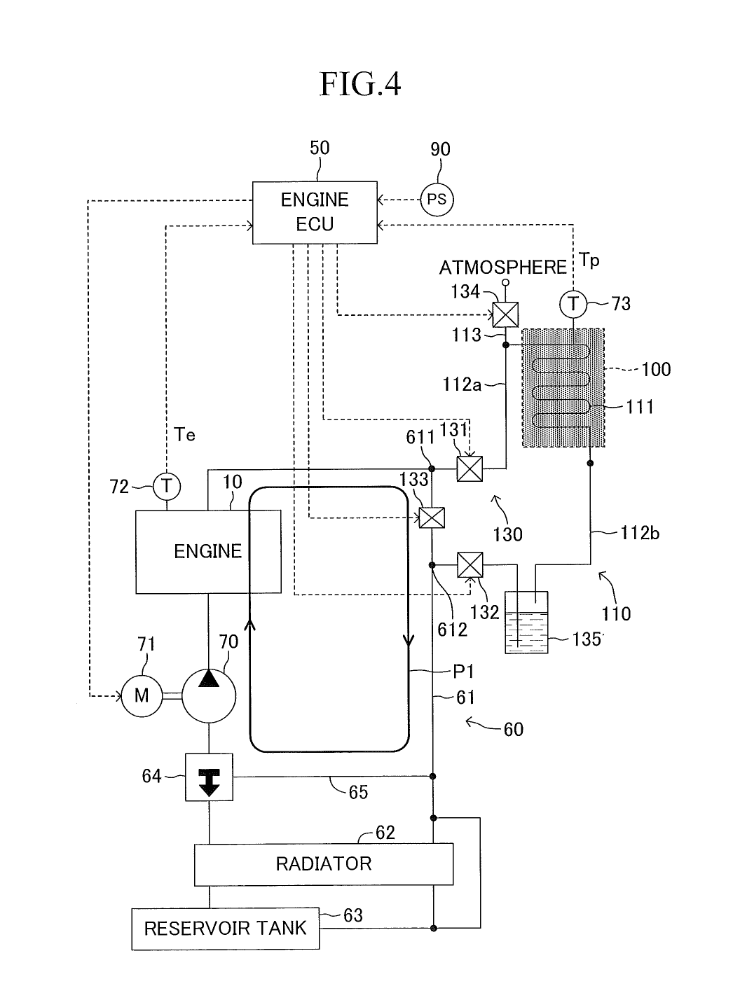

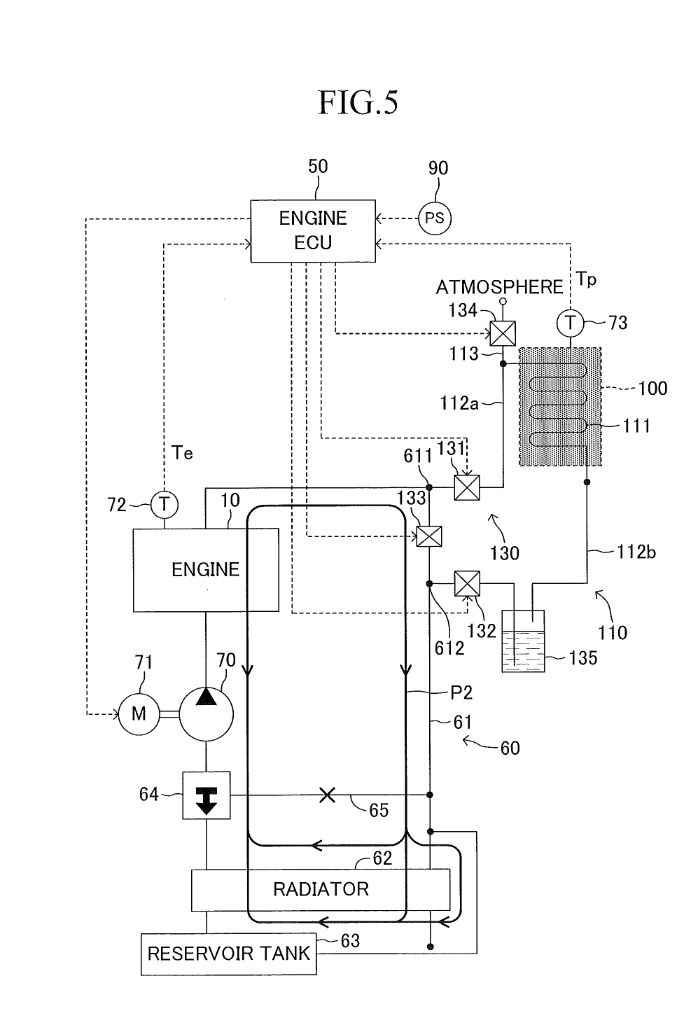

A description is now given of a circulation passage for the coolant in a mode in which the panel cooling device 110 is not activated. When the panel cooling device 110 is not activated, the engine ECU 50 stops the current supply to the cooling actuator 130. As a result, only the third on-off valve 133, which is the normally open electromagnetic valve, is maintained in the open state, and the first on-off valve 131, the second on-off valve 132, and the fourth on-off valve 134, which are normally closed electromagnetic valves, are maintained in the closed state. When the water pump 70 is driven, and the coolant temperature around the thermostat valve 64 is lower than the warmup end temperature, the valve position of the thermostat valve 64 is the warmup position. Therefore, as the arrows of FIG. 4 indicate, an engine coolant warmup flow passage P1 is formed. When the coolant temperature increases, and the coolant temperature around the thermostat valve 64 becomes equal to or higher than the warmup end temperature, the valve position of the thermostat valve 64 switches from the warmup position to the normal position. As a result, as the arrows of FIG. 5 indicate, an engine coolant normal flow passage P2 is formed.

If the coolant temperature in the engine 10 is high when the system is activated (when the power switch 90 is turned on), the warmup operation does not need to be carried out. Therefore, in the hybrid system, the vehicle V can be controlled to travel by the motor 15 without activating the engine 10. On the other hand, when the coolant temperature is low, the entire engine drive system is warmed up by always activating the engine 10 for the warmup operation. Therefore, when the engine 10 is cool, an additional fuel is necessary for the warmup operation. Moreover, during the warmup operation, the quality of an exhaust gas is lower than that during the normal operation.

Thus, according to this embodiment, a configuration capable of omitting the warmup operation by driving the engine 10, or decreasing a warmup operation period is provided. Specifically, when the hybrid system is not activated, and the exchange condition for the coolant is satisfied, the engine coolant passage 61 and the panel-side pipe 111 are communicated with each other so as to form a coolant circulation passage in which the engine 10 and the panel-side pipe 111 are serially arranged, and the water pump 70 is then driven. As a result, the cool coolant accumulated in the engine coolant passage 61 is drawn to the panel-side pipe 111, and the warmed coolant accumulated in the panel-side pipe 111 is returned to the engine coolant passage 61. Thus, the coolant warmed by the solar panel 100 can be used to warm up the engine 10. Moreover, the solar cell 102 installed in the solar panel 100 decreases in the electric power generation efficiency as the temperature increases. However, the coolant in the panel-side pipe 111 is replaced by the cool coolant accumulated in the engine coolant passage 61. The electric power generation efficiency of the solar cell 102 can thus be increased.

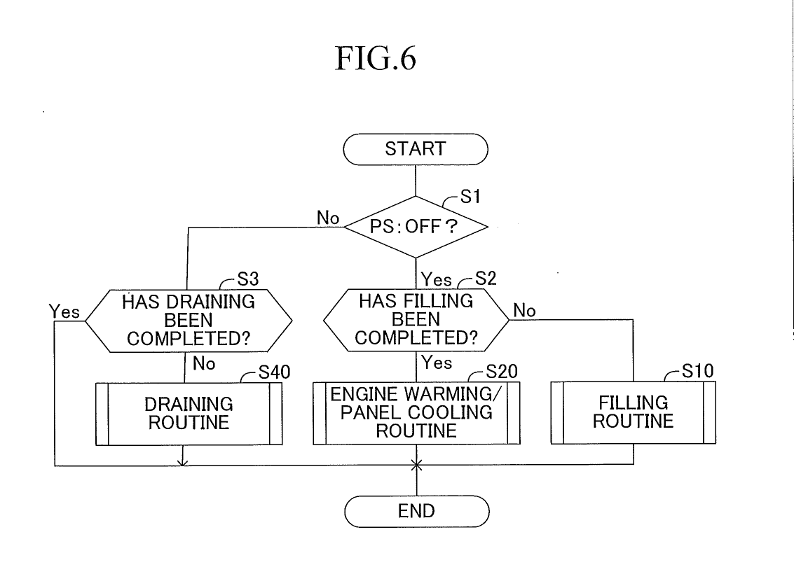

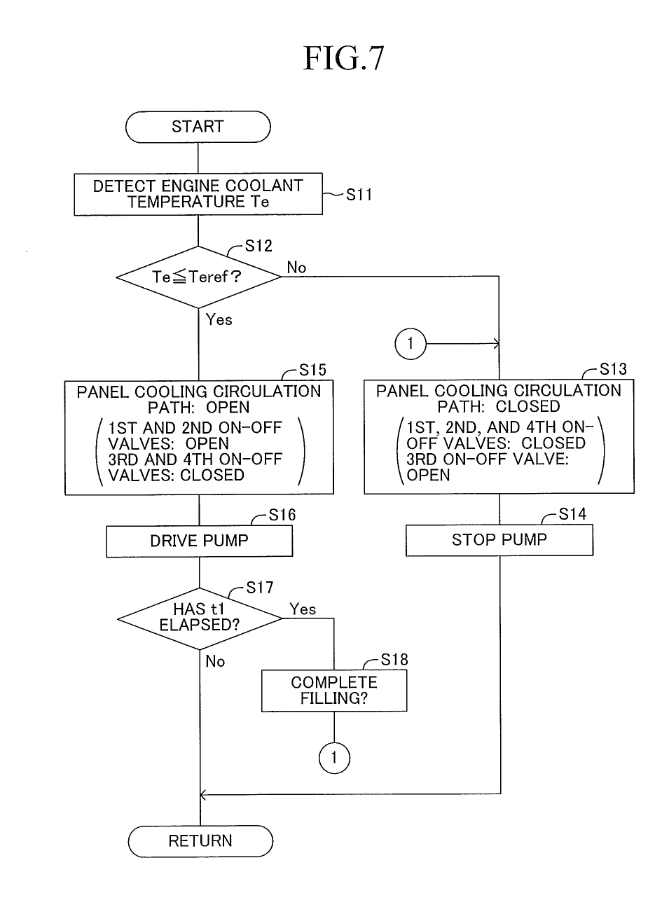

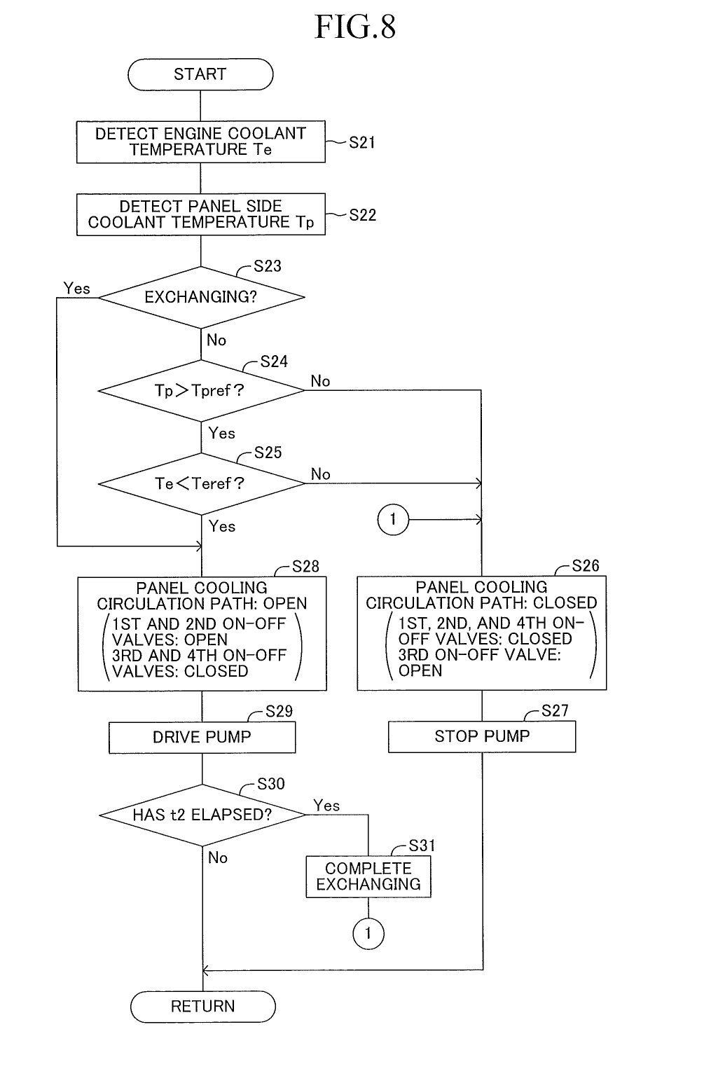

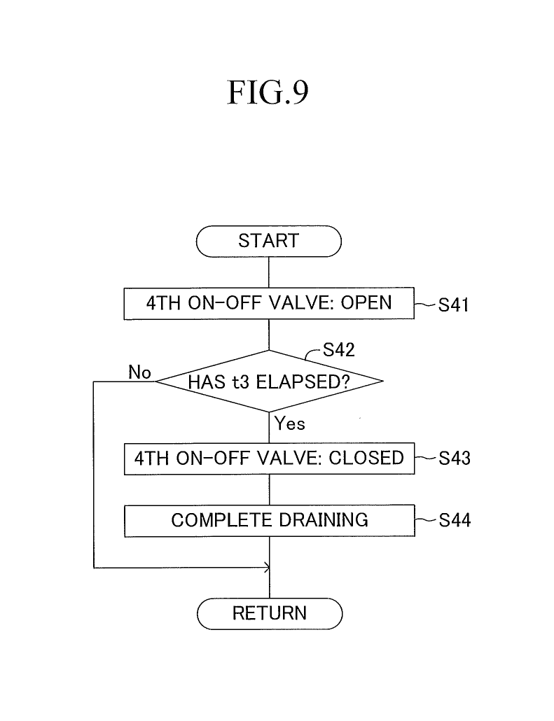

This processing is carried out by the engine ECU 50 controlling operations of the panel cooling device 110 (cooling actuator 130) and the water pump 70. A description is now given of engine-panel coolant exchange control carried out by the engine ECU 50. FIG. 6 is a flowchart illustrating the engine-panel coolant exchange control routine (main routine) executed by the engine ECU 50. Moreover, FIGS. 7 to 9 illustrate subroutines integrated into the engine-panel coolant exchange control routine. FIG. 7 illustrates a filling routine, FIG. 8 illustrates an engine warming/panel cooling routine, and FIG. 9 illustrates a draining routine.

The engine-panel coolant exchange control routine is repeatedly executed at a predetermined short cycle. When this routine is invoked, in Step S1, the engine ECU 50 determines whether or not the power switch 90 is in an OFF state. In other words, the engine ECU 50 determines whether the hybrid system is not activated or activated. It should be noted that the engine ECU 50 is configured to receive electric power supply from the electricity storage device 20 so as to enable driving of the water pump 70 and the cooling actuator 130 even when the power switch 90 is in the OFF state.

When the power switch 90 is turned off, in Step S2, the engine ECU 50 determines whether or not the filling processing has been completed. As described later, when the driver turns on the power switch 90, the coolant accumulated in the panel-side pipe 111 of the solar panel 100 is drained (referred to as draining processing), and when the driver turns off the power switch 90, the panel-side pipe 111 is filled with the coolant after the temperature of the coolant in the engine 10 decreases. Step S2 is processing of determining whether or not filling processing of filling the panel-side pipe 111, from which the coolant has been drained, with the coolant again has been completed.

When the filling processing has not been completed, the engine ECU 50 controls the processing to proceed to the filling routine (refer to FIG. 7) in Step S10. When the filling routine is invoked, in Step S11, the engine ECU 50 reads the engine coolant temperature Te detected by the engine-side temperature sensor 72, and, in Step S12, which follows, determines whether or not the engine coolant temperature Te is equal to or lower than a filling set temperature Teref. When the coolant is not cool (No in Step S12), in Step S13, the engine ECU 50 brings the operation of the cooling actuator 130 of the panel cooling device 110 into a stop state. In other words, the ECU 50 brings the first on-off valve 131, the second on-off valve 132, and the fourth on-off valve 134 into the closed state, and brings the third on-off valve 133 into the open state. Then, in Step S14, the engine ECU 50 brings the water pump 70 into the stop state.

When the engine ECU 50 executes the processing in Step S14, the engine ECU 50 once finishes the filling routine, and returns the processing to the engine-panel coolant exchange control routine (main routine). As a result, the engine-panel coolant exchange control routine is once finished. The engine ECU 50 repeats the engine-panel coolant exchange control routine at a predetermined short cycle. Thus, while the engine coolant temperature Te is higher than the filling set temperature Teref, the cooling actuator 130 and the water pump 70 are maintained in the stop state.

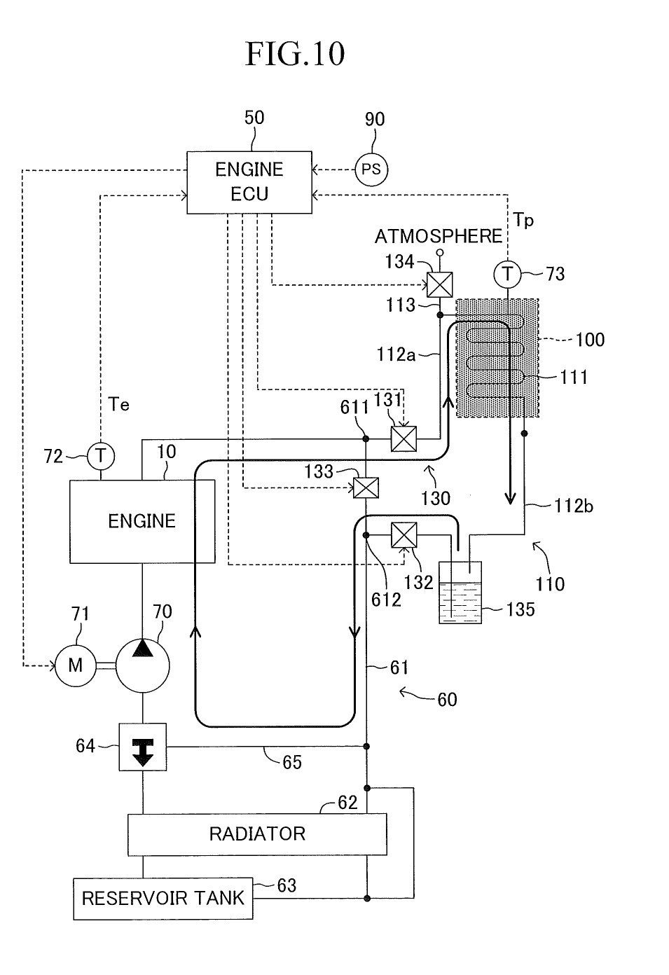

When the temperature of the coolant in the engine 10 decreases, and the engine coolant temperature Te thus becomes equal to or lower than the filling set temperature Teref (Yes in Step S12), in Step S15, the engine ECU 50 brings the first on-off valve 131 and the second on-off valve 132 into the open state, and brings the third on-off valve 133 and the fourth on-off valve 134 in the closed state. Thus, the panel-side pipe 111 and the engine coolant passage 61 come to communicate with each other via the coupling pipe 112 (the outward passage pipe 112a and the inward passage pipe 112b). Then, in Step S16, the engine ECU 50 drives the water pump 70 at the number of revolutions set in advance. As a result, as the arrows of FIG. 10 indicate, the coolant accumulated in the reservoir 135 is drawn, and the supply of the coolant to the panel-side pipe 111 starts.

Then, in Step S17, the engine ECU 50 determines whether or not a certain period t1 has elapsed after the water pump 70 was activated. The certain period t1 is set to a period required to fill the panel-side pipe 111 with the coolant by driving the water pump 70. When a drive period of the water pump 70 is less than the certain period t1, the engine ECU 50 once finishes the filling routine, and returns the processing to the engine-panel coolant exchange control routine (main routine). As a result, the above-mentioned processing is repeated.

When the drive period of the water pump 70 reaches the certain period t1 (Yes in Step S17), in Step S18, the engine ECU 50 determines that the panel-side pipe 111 is filled with the coolant, and controls the processing to proceed to Step S13. As a result, the communication between the panel-side pipe 111 and the engine coolant passage 61 is shut off (Step S13), and the water pump 70 is stopped (Step S14). The filling routine is finished in this way.

When the panel-side pipe 111 is filled with the coolant, in Step S20, the engine ECU 50 executes the engine warming/panel cooling routine (FIG. 8). This engine warming/panel cooling routine is repeatedly executed while the power switch 90 is in the OFF state.

When the engine warming/panel cooling routine is invoked, in Step S21, the engine ECU 50 reads the engine coolant temperature Te detected by the engine-side temperature sensor 72, and, then in Step S22, which follows, reads the panel-side coolant temperature Tp detected by the panel-side temperature sensor 73.

Then, in Step S23, the engine ECU 50 determines whether or not the coolant is being exchanged. Immediately after this routine is invoked, the coolant is not being exchanged, and the engine ECU 50 thus controls the processing to proceed to Step S24. In Step S24, the engine ECU 50 determines whether or not the panel-side coolant temperature Tp is higher than a panel-side exchange set temperature Tpref set in advance, and when the panel-side coolant temperature Tp is equal to or lower than the panel-side exchange set temperature Tpref, the engine ECU 50 controls the processing to proceed to Steps S26 and S27. Processing in Steps S26 and S27 is the same as the above-mentioned processing in Steps S13 and S14. Thus, the current supply to the cooling actuator 130 is stopped, the first on-off valve 131, the second on-off valve 132, and the fourth on-off valve 134 are maintained in the closed state, the third on-off valve 133 is maintained in the open state, and the water pump 70 is maintained in the stop state.

When the solar panel 100 is heated by the irradiation of the sunlight, the heat of the solar panel 100 is transferred to the coolant accumulated in the panel-side pipe 111. As a result, an increase in the temperature of the solar panel 100 is suppressed, and the temperature of the coolant increases accordingly. When the panel-side coolant temperature Tp increases to a temperature higher than the panel-side exchange set temperature Tpref (Yes in S24), in Step S25, the engine ECU 50 determines whether or not the engine coolant temperature Te is lower than an engine-side exchange set temperature Teref set in advance, and, when the engine coolant temperature Te is lower than the engine-side exchange set temperature Teref, controls the processing to proceed to Steps S28 and S29. The engine-side exchange set temperature Teref is set to a value lower than the panel-side exchange set temperature Tpref. It should be noted that the engine-side exchange set temperature Teref is a threshold used to determine whether or not an engine drive system needs to be warmed up, and the panel-side exchange set temperature Tpref is a threshold used to determine whether or not the solar panel 100 needs to be cooled down.

The temperature of the coolant for the engine 10 decreases as the time elapses after the engine stop. When the engine coolant temperature Te becomes lower than the engine-side exchange set temperature Teref (Step S25), the exchange condition for the coolant is satisfied, and the engine ECU 50 controls the processing to proceed to Steps S28 and S29. Processing in Steps S28 and S29 is the same as the above-mentioned processing in Steps S15 and S16.

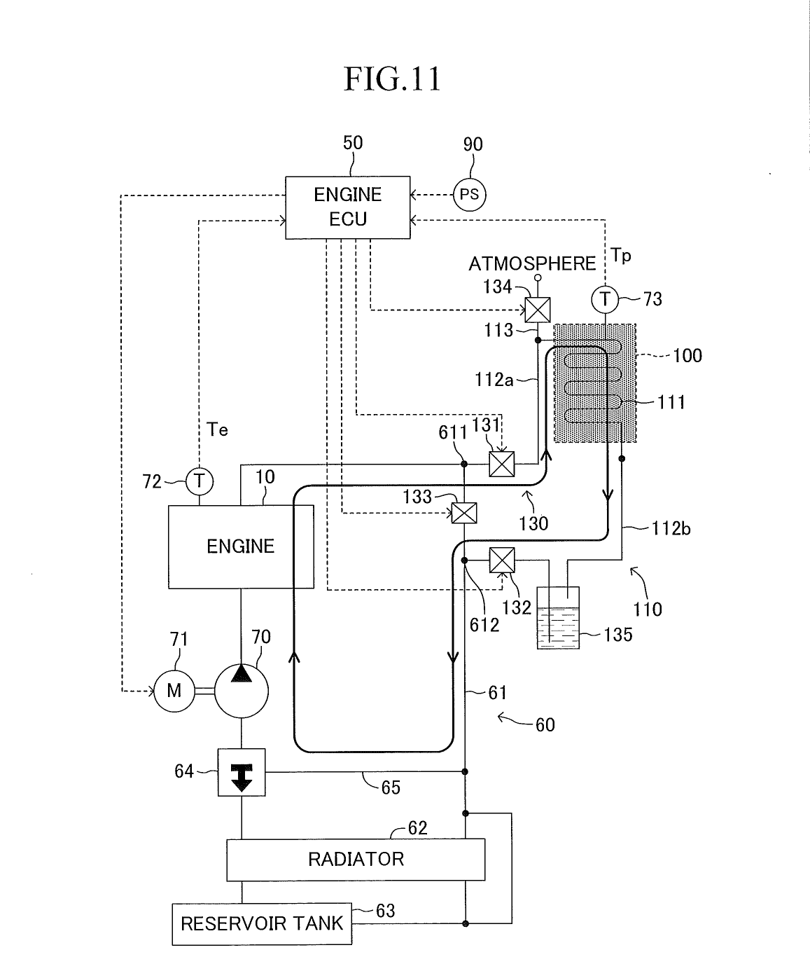

Thus, the first on-off valve 131 and the second on-off valve 132 are opened, and the third on-off valve 133 and the fourth on-off valve 134 are closed (Step S28). As a result, the panel-side pipe 111 and the engine-side coolant passage 61 are communicated with each other via the coupling pipe 112 (the outward passage pipe 112a and the inward passage pipe 112b). Simultaneously, the water pump 70 is driven (Step S29). As a result, as the arrows of FIG. 11 indicate, the coolant starts circulating through a circulation path constructed by the engine coolant passage 61, the coupling pipe 112, and the panel-side pipe 111. This circulation path is referred to as panel cooling circulation path. The panel cooling circulation path constructs a common circulation path serially connecting the water pump 70, the engine 10, and the panel-side pipe 111 with each other.

In this way, the exchange between the cool coolant accumulated in the engine coolant passage 61 and the warmed coolant accumulated in the panel-side pipe 111 starts.

Then, in Step S30, the engine ECU 50 determines whether or not an elapsed period after the start of the exchange of the coolant, namely an elapsed period after the processing in Steps S28 and S29 is carried out, has reached a certain period t2. The certain period t2 is set to a period required to return the coolant accumulated in the panel-side pipe 111 to the engine coolant passage 61. When the exchange period of the coolant is less than the certain period t2, the engine ECU 50 once finishes the engine warming/panel cooling routine, and returns the processing to the engine-panel coolant exchange control routine (main routine). As a result, the above-mentioned processing is repeated.

In this case, after the processing of exchanging the coolant (Steps S27 and S28) is once started, the processing in Steps S24 and S25 is skipped. Thus, the exchange processing for the coolant continues independently of the panel-side coolant temperature Tp and the engine coolant temperature Te. As a result, the cool coolant in the engine coolant passage 61 is drawn to the panel-side pipe 111 via the outward passage pipe 112a, and the warmed coolant in the panel-side pipe 111 is returned to the engine coolant passage 61 via the inward passage pipe 112b.

Then, when the exchange period of the coolant reaches the certain period t2 (Yes in Step S30), in Step S31, the engine ECU 50 determines that the exchange processing for the coolant has been completed, and controls the processing to proceed to Steps S26 and S27. As a result, the communication between the panel-side pipe 111 and the engine coolant passage 61 is shut off (Step S26), and the water pump 70 is stopped (Step S27).

When the exchange processing for the coolant is completed, the engine ECU 50 once finishes the engine warming/panel cooling routine, and returns the processing to the engine-panel coolant exchange control routine (main routine). As a result, when the engine warming/panel cooling routine is executed for the next time, the determination in Step S23 results in “No”, and the exchange condition for the coolant is thus determined.

As a result of the exchange between the cool coolant accumulated in the engine coolant passage 61 and the warmed coolant accumulated in the panel-side pipe 111 in this way, the solar panel 100 can be cooled by using the coolant drawn from the engine coolant passage 61 to the panel-side pipe 111. Simultaneously, the coolant returned from the panel-side pipe 111 to the engine coolant passage 61 can be used to warm the engine 10.

The solar panel 100 is heated by the radiation energy of the sunlight during the sunshine, and thus becomes higher in the temperature than the outdoor temperature. For example, even when the outdoor temperature is 30° C., the temperature of the solar cell 102, which corresponds to the rear surface of the solar panel 100, may exceed 60° C. Therefore, the coolant drawn to the panel-side pipe 111 exchanges the heat with the solar panel 100, and thus increases in the temperature. This heat exchange cools the solar cell 102 of the solar panel 100. The solar cell 102 decreases in the electric power generation efficiency as the temperature thereof increases. However, the solar cell 102 is cooled by the heat exchange with the coolant, which suppresses the decrease in the electric power generation efficiency.

Moreover, the engine 20 is warmed by the heat exchange with the hot coolant returned from the panel-side pipe 111. In other words, the engine 20 is heated by the heat taken from the solar panel 100. Thus, the same effect as the warmup operation is obtained without activating the engine 10.

The engine ECU 50 repeats the engine-panel coolant exchange control routine at the predetermined short cycle. Therefore, when the power switch 90 is in the OFF state (Yes in Step S1), the panel-side pipe 111 is initially filled with the coolant, and, then, the coolant is exchanged for the certain period t2 each time the exchange condition for the coolant is satisfied.

In Step S1, the engine ECU 50 determines the state of the power switch 90 each time the engine-panel coolant exchange control routine is invoked. When the power switch 90 is in an ON state (No in Step S1), in Step S3, the engine ECU 50 determines whether or not the draining processing for the panel-side pipe 111 has been completed. When the draining processing has been completed, the engine ECU 50 once finishes the engine-panel coolant exchange control routine, and when the draining processing has not been completed, the engine ECU 50 executes the draining routine (refer to FIG. 9) in Step S40.

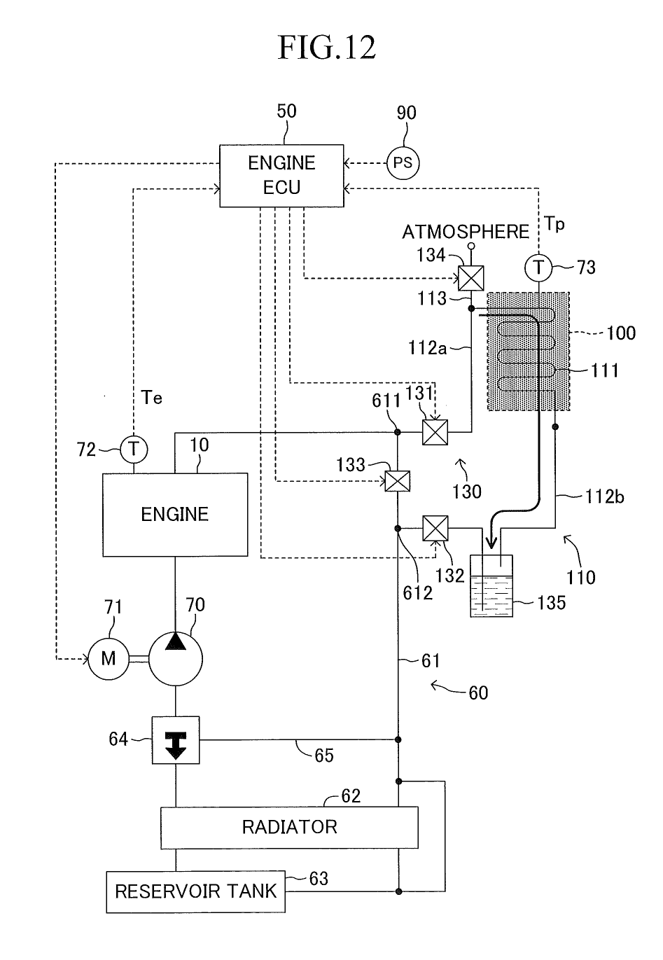

When the draining routine is invoked, in Step S41, the engine ECU 50 outputs the drive signal to the fourth on-off valve 134 out of the four on-off valves 131 to 134 of the cooling actuator 130, thereby bringing the fourth on-off valve 134 into the open state (the first and second on-off valves 131 and 132 are maintained in the closed state, and the third on-off valve 133 is maintained in the open state). The fourth on-off valve 134 is installed on the atmospheric relief pipe 113, and one end of the panel-side pipe 111 is thus opened to the atmosphere. Moreover, the other end of the panel-side pipe 111 is communicated with the reservoir 135 via the inward passage pipe 112b. Therefore, as the arrows of FIG. 12 indicate, the coolant accumulated in the panel-side pipe 111 starts flowing to the reservoir 135 by its own weight.

Then, in Step S42, the engine ECU 50 determines whether or not a certain period t3 has elapsed after the fourth on-off valve 134 was opened. The certain period t3 is set to a period required to cause an entire amount of the coolant accumulated in the panel-side pipe 111 to flow to the reservoir 135. When the certain period t3 has not elapsed after the fourth on-off valve 134 was opened (No in Step S42), the engine ECU 50 once finishes the draining routine, and controls the processing to proceed to the engine-panel coolant exchange control routine (main routine). As a result, the draining routine is repeatedly executed at a predetermined short cycle. Thus, the open state of the fourth on-off valve 134 is maintained until the certain period t3 has elapsed after the fourth on-off valve 134 was opened.

When the certain period t3 has elapsed after the fourth on-off valve 134 was opened (Yes in Step S42), in Step S43, the engine ECU 50 closes the fourth on-off valve 134, and, in Step S44, determines that the draining processing has been completed. The coolant in the panel-side pipe 111 is replaced with the air while the certain period t3 elapses in this way.

It should be noted that when the engine ECU 50 receives the engine requested output value from the hybrid ECU during the execution of the draining routine, the engine ECU 50 activates the engine 10 while executing the draining routine (maintaining the fourth on-off valve 134 in the open state). Moreover, the engine ECU 50 activates the water pump 70 in response to the activation of the engine 10, thereby circulating the coolant through the engine coolant passage 61.

The vehicle V according to this embodiment described above provides the following actions and effects.

1. When the engine 10 is stopped, the engine coolant passage 61 and the panel-side pipe 111 are communicated with each other via the coupling pipe 112, and the water pump 70 is driven. As a result, the cool coolant accumulated in the engine coolant passage 61 is drawn to the panel-side pipe 111, and the warmed coolant accumulated in the panel-side pipe 111 is returned to the engine coolant passage 61. Thus, the cool coolant obtained during the stop of the engine 10 can be used to cool the solar panel 100, and the electric power generation efficiency of the solar panel 100 (solar cell 102) can thus be increased.

2. The coolant in the panel-side pipe 111 exchanges the heat with the solar panel 100, thereby increasing the temperature thereof. Thus, the warmed coolant is returned to the engine coolant passage. As a result, the engine 10 can be warmed before the engine 10 is activated. Thus, the heat storage of the solar panel 100 can be effectively used to omit the warmup operation, or to reduce the warmup operation period. As a result, the fuel efficiency can be increased, and the quality of the exhaust gas can be increased.

3. When the panel-side pipe 111 is filled with the coolant, the center of gravity of the vehicle V is moved upward, and the motion performance of the vehicle V may decrease due to the weight balance of the vehicle V. Thus, according to this embodiment, when a start of the travel of the vehicle V is expected, in other words, turning on of the power switch 90 is detected, the coolant is drained from the panel-side pipe 111. As a result, while the vehicle V is traveling, the coolant has been drained from the panel-side pipe 111, and a decrease in the motion performance of the vehicle V can be reduced.

4. Such a condition that the panel-side coolant temperature Tp is higher than the panel-side exchange set temperature Tpref and the engine coolant temperature Te is lower than the engine-side exchange set temperature Teref is considered as the exchange condition for the coolant so that the coolant accumulated in the engine coolant passage 61 and the coolant accumulated in the panel-side pipe 111 are exchanged with each other. Moreover, the exchange processing for the coolant is maintained for the certain period t2. Therefore, the heat transfer by the coolant can be appropriately carried out. Moreover, the wasteful drive of the water pump 70 can be prevented.

5. The water pump 70 installed for the engine cooling device 60 can be used to exchange the coolant, and the embodiment can be carried out at a low cost without newly installing a special pump.

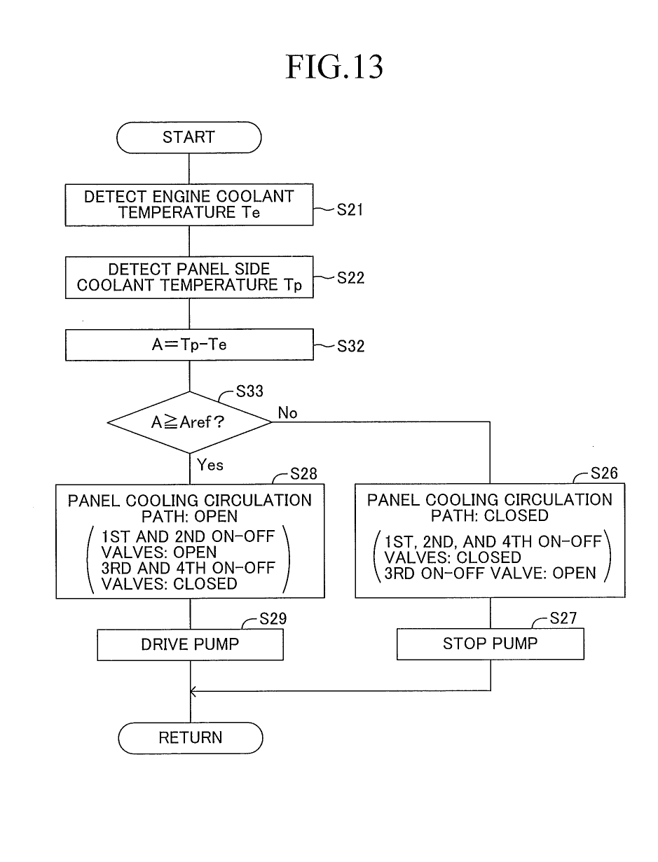

A description is now given of a modified example of the engine warming/panel cooling routine. FIG. 13 is a flowchart illustrating the engine warming/panel cooling routine according to the modified example. This engine warming/panel cooling routine is to be executed in place of the above-mentioned engine warming/panel cooling routine (FIG. 8) according to the embodiment. In the following, like processing are denoted by like step numerals as of the engine warming/panel cooling routine according to the embodiment in FIG. 13, and a description thereof is therefore omitted.

In Step S32, the engine ECU 50 calculates a temperature difference A (=Tp−Te) between the panel-side coolant temperature Tp and the engine coolant temperature Te. Then, in Step S33, the engine ECU 50 determines whether or not the temperature difference A is equal to or more than an exchange set temperature difference Aref set in advance. The temperature difference A is less than the exchange set temperature difference Aref immediately after the panel-side pipe 111 is filled with the coolant. Therefore, in Step S33, the engine ECU 50 makes a determination, “No”, and controls the processing to proceed to Steps S26 and S27. Thus, the current supply to the cooling actuator 130 is stopped, the first on-off valve 131, the second on-off valve 132, and the fourth on-off valve 134 are maintained in the closed state, the third on-off valve 133 is maintained in the open state, and the water pump 70 is maintained in the stop state.

When the solar panel 100 is heated by the irradiation of the sunlight, the heat of the solar panel 100 is transferred to the coolant accumulated in the panel-side pipe 111. As a result, an increase in the temperature of the solar panel 100 is suppressed, and the temperature of the coolant increases accordingly. When the temperature of the coolant in the panel-side pipe 111 increases, and the temperature difference A between the panel-side coolant temperature Tp and the engine coolant temperature Te becomes equal to or more than the exchange set temperature difference Aref (Yes in Step S33), the engine ECU 50 controls the processing to proceed to Steps S28 and S29.

As a result, the coolant accumulated in the engine coolant passage 61 is drawn to the panel-side pipe 111 via the outward passage pipe 112a, and the coolant accumulated in the panel-side pipe 111 is returned to the engine coolant passage 61 via the inward passage pipe 112b. When the circulation of the coolant starts, the panel-side coolant temperature Tp is higher than the engine coolant temperature Te. Therefore, as a result of the circulation of the coolant by the water pump 70, the coolant at a relatively lower temperature (lower than that of the coolant accumulated immediately before the start of the circulation) flows into the panel-side pipe 111, and the coolant at a relatively higher temperature (higher than that of the coolant accumulated immediately before the start of the circulation) flows into the engine coolant passage 61.

The cool coolant accumulated in the engine coolant passage 61 and the warmed coolant accumulated in the panel-side pipe 111 are exchanged with each other by circulating the coolant in this way. As a result, the temperature difference A decreases. When the temperature difference A decreases to be less than the exchange set temperature difference Aref, the engine ECU 50 controls the processing to proceed to Steps S26 and S27, and closes the panel cooling circulation path, thereby stopping the circulation of the coolant.

The above-mentioned engine warming/panel cooling routine according to the modified example can effectively use the heat accumulated in the solar panel 100 so as to warm the engine 100, and simultaneously can increase the electric power generation efficiency of the solar panel 100 similarly to the engine warming/panel cooling routine according to the embodiment.

In the above, the vehicle V in this embodiment (including the modified example) has been described, but the present invention is not limited to the above-mentioned embodiment, and various changes are possible within the range not departing from the object of the present invention.

For example, according to this embodiment, a description is given of the hybrid vehicle, but the vehicle subject to the present invention is not limited to the hybrid vehicle, and a vehicle including only the engine 10 as a wheel driving source may be a vehicle subject to the present invention.

Moreover, according to this embodiment, the temperature of the coolant in the panel-side pipe 111 is detected as the temperature state of the solar panel 100 (solar cell 102), but such a configuration as to directly detect the temperature of the solar panel 100 may be obtained instead. For example, a temperature sensor (referred to as panel temperature sensor) may be installed on the solar panel 100, and, in Step S22, a panel temperature Tp detected by the panel temperature sensor may be read by the engine ECU 50.

Moreover, according to this embodiment, the panel-side pipe 111 is filled with the coolant when the power switch 90 is in the OFF state, but, for example, when the outside air temperature is extremely low, or at night without the sunshine, such a case that the coolant is adversely cooled in the panel-side pipe 111 is conceivable. Thus, such a configuration that the panel-side pipe 111 is prevented from being filled with the coolant when a filling permission condition set in advance is not satisfied (for example, when the outside air temperature is lower than a filling permission set temperature or when the current time point is in a filling inhibition time zone) may be obtained. In this case, for example, processing of determining whether or not the filling permission condition is satisfied may be inserted between Steps S1 and S2. When the filling permission condition is determined not to be satisfied, the processing may be controlled to proceed to Step S3, and when the filling permission condition is determined to be satisfied, the processing may be controlled to proceed to Step S2.

According to this embodiment, the single meandering pipe is employed as the panel-side pipe 111, but, for example, such a configuration that a plurality of pipes are arranged in parallel, a coolant inlet opening of each pipe is connected to the outward passage pipe 112a, and a coolant outlet opening of the each pipe is connected to the inward passage pipe 112b may be employed.

Moreover, according to this embodiment, in the filling routine, after the engine coolant temperature Te decreases to a temperature equal to or lower than the filling set temperature Teref, the coolant is supplied to the panel-side pipe 111, but the engine coolant temperature Te does not always need to be detected. For example, in Step S11, an elapsed period after the engine 10 stops may be measured, and, in Step S12, whether or not the measured engine stop period is longer than a set period assumed to be required for the engine coolant temperature Te to decrease to a temperature equal to or lower than the filling set temperature Teref may be determined.

Moreover, according to this embodiment, the coolant is exchanged (the cool coolant accumulated in the engine coolant passage 61 and the warmed coolant accumulated in the panel-side pipe 111 are exchanged with each other) only when the engine 10 is stopped, but such a configuration that the coolant exchange processing is carried out when the engine is activated may be employed. For example, when the engine is activated, the engine warming/panel cooling routine (FIG. 8 or 13) may be executed. In this case, the draining routine may be executed after the exchange processing for the coolant, or may be omitted.

What is claimed is:

1. A vehicle, comprising:
a solar panel installed on the vehicle;
a panel-side pipe arranged in a region on a rear surface side, which is an opposite side to a light reception surface, of the solar panel, so as to enable heat exchange with the solar panel;
an engine cooling device for circulating a coolant through an engine coolant passage;
a coupling pipe comprising an outward passage and an inward passage, for coupling the engine coolant passage and the panel-side pipe to each other; and
an engine-panel coolant exchange device for drawing the coolant in the engine coolant passage to the panel-side pipe via the outward passage, and returning the coolant in the panel-side pipe to the engine coolant passage via the inward passage.

2. A vehicle according to claim 1, wherein:
the engine cooling device comprises an electric pump for circulating the coolant through the engine coolant passage; and
the engine-panel coolant exchange device is configured to use the electric pump to draw the coolant in the engine coolant passage to the panel-side pipe.

3. A vehicle according to claim 1, further comprising draining means for draining, when a start of a travel of the vehicle is expected, the coolant from the panel-side pipe via a part of the inward passage.

4. A vehicle according to claim 1, further comprising:
temperature acquisition means for acquiring an engine-side temperature representing a temperature of the coolant in the engine coolant passage, and a panel-side temperature representing one of a temperature of the solar panel and a temperature of the coolant in the panel-side pipe; and
exchange control means for controlling an operation of the engine-panel coolant exchange device based on the acquired engine-side temperature and panel-side temperature.

5. A vehicle according to claim 4, wherein the exchange control means is configured to operate the engine-panel coolant exchange device under a condition that the panel-side temperature is higher than the engine-side temperature by an amount equal to or more than an exchange set temperature difference.

6. A vehicle according to claim 4, wherein the exchange control means is configured to operate the engine-panel coolant exchange device under a condition that the panel-side temperature is higher than a panel-side exchange set temperature, and the engine-side temperature is lower than an engine-side exchange set temperature set to a temperature lower than the panel-side exchange set temperature.
